(19) United States
(12) Patent Application Publication
(10) Pub. No.: US 2010/0241578 A1
(43) Pub. Date: Sep. 23, 2010

(54) Notification Management

(76) Inventor: Michael McLaughlin, Gardnerville, CA (US)

Correspondence Address: TI Law Group, 2055 Junction Avenue, #205, San Jose, CA, 95131-2116, US

(21) Appl. No.: 12/728,121

(22) Filed: Mar. 19, 2010

Related U.S. Application Data
(60) Provisional application No. 61/161,507, filed on Mar. 19, 2009.

(51) Int. Cl. G06Q 10/00; G06Q 50/00; G06F 15/16

(52) U.S. Cl. 705/304; 709/206

(57) ABSTRACT

In one embodiment, a system of notification management having a notification manager may comprise a memory configured to store instructions and to store information concerning a plurality of service providers and a processor configured to execute the instructions stored in the memory, wherein execution of the instructions generates a notification based on status information provided by a service provider. The processor may also be configured to: (i) receive contact information and a designation concerning a service provider from a customer, the designated service provider being selected from the plurality of service providers stored in memory; (ii) send an alert to the designated service provider, the alert concerning the customer associated with the received contact information; (iii) receive status information from the service provider in response to the alert; and (iv) send the generated notification to the customer using the received contact information.

### CROSS-REFERENCE TO RELATED APPLICATIONS

This application claims priority from Patent Application No. 61/161,507, entitled “Notification Management,” filed on Mar. 19, 2009, which is incorporated herein by reference for all purposes.

### FIELD OF THE INVENTION

The present disclosure relates generally to notification management and more specifically to notification management for service providers.

### BACKGROUND OF THE INVENTION

Customer service is very important, no matter what business you are in. Notification management and report processing technologies have permeated business information systems to the point where the reliability, scalability, and flexibility of report processing directly impacts the operational efficiency of an organization's business processes. Now, customers would like to be kept informed of the status of their orders and/or service requests. However, many businesses are generally lacking when it comes to communication with their customers and thus lose repeat business and/or customer referrals. Service providers are continually looking for ways to efficiently and effectively communicate with their customers before, during, and after the initial encounter with the customer.

### OVERVIEW

Embodiments described herein provide for notification management. In one embodiment, a system of notification management having a notification manager may comprise a memory configured to store instructions and to store information concerning a plurality of service providers and a processor configured to execute the instructions stored in the memory, wherein execution of the instructions generates a notification based on status information provided by a service provider. The processor may also be configured to: (i) receive contact information and a designation concerning a service provider from a customer, the designated service provider being selected from the plurality of service providers stored in memory; (ii) send an alert to the designated service provider, the alert concerning the customer associated with the received contact information; (iii) receive status information from the service provider in response to the alert; and (iv) send the generated notification to the customer using the received contact information.

In another embodiment, a system of notification management may include a central notification manager having a processor configured to: (i) receive status notification from one of a plurality of service providers, the status notification including customer information and a status information; (ii) retrieve customer contact information from a customer database; (iii) generate a customer notification based on the status information provided in the status notification; and (iv) send the customer notification to a customer based upon the customer contact information, the customer notification including the status information provided by the service provider. The system may also have a service provider server having a processor configured to receive a status update on the customer, and transmit a status notification concerning the customer to the central notification manager.

In one embodiment, a method of notification management may comprise receiving customer contact information and a designation concerning a service provider, sending an alert to the designated service provider, the alert concerning a customer associated with the received contact information, receiving status information from the service provider in response to the alert, generating a notification based on the status information provided by the service provider, and sending the notification to the customer using the received contact information.

In another embodiment, a computer-readable storage medium, having embodied thereon a program, the program being executable by a processor to perform a method for notification management may comprise receiving customer contact information and a designation concerning a service provider, sending an alert to the designated service provider, the alert concerning the customer associated with the received contact information, receiving status information from the service provider in response to the alert, generating a notification based on the status information provided by the service provider, and sending the notification to the customer using the received contact information.

The present invention provides other hardware configured to perform the methods of the invention, as well as software stored in a machine-readable medium (e.g., a tangible storage medium) to control devices to perform these methods. These and other features will be presented in more detail in the following detailed description of the invention and the associated figures.

### BRIEF DESCRIPTION OF THE DRAWINGS

The accompanying drawings, which are incorporated into and constitute a part of this specification, illustrate one or more example embodiments and, together with the description of example embodiments, serve to explain the principles and implementations.

In the drawings:

FIG. 1 illustrates a block diagram of an example notification management system.

FIG. 2 illustrates a flow chart of an example method of notification management.

FIG. 3 illustrates a flow diagram of another example method of notification management.

FIG. 4 illustrates a screen shot of an example listing of a plurality of service providers.

FIG. 5 illustrates an example graphical user interface used to obtain customer contact information.

FIGS. 6A and 6B illustrate example screen shots of an appointment calendar.

FIGS. 7A-7D illustrate sample screen shots of example status information for a customer.

FIG. 8 illustrates an example screen shot of upcoming appointments.

FIGS. 9A and 9B illustrate example screen shots listing customer information and status information.

FIG. 10 illustrates an example screen shot of an example alert.

FIG. 11 illustrates a sample screen shot displaying a history list of customer appointments.

FIG. 12 illustrates an example screen shop to set up customer appointments by a service provider.

FIG. 13 illustrates an example screen shot of a graphical user interface a service provider may use to contact a customer.

FIG. 14 illustrates an exemplary computing system.

FIG. 15 is a block diagram of an example computing system.

### DESCRIPTION OF EXAMPLE EMBODIMENTS

Embodiments are described herein in the context of notification management. The following detailed description is illustrative only and is not intended to be in any way limiting. Other embodiments will readily suggest themselves to such skilled persons having the benefit of this disclosure. Reference will now be made in detail to implementations as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

Embodiments described herein provide for notification management. One or more customers may provide contact information and a designated service provider to a central notification manager. The central notification manager can transmit the customer contact information to the designated service provider. The transmission may be an electronic mail (email), text message, facsimile or any similar electronic means for messaging.

The transmission may include an alert having a plurality of options for notification. For example transmission may allow the service provider to select from a plurality of status selections, request the customer to reschedule an appointment, allow the service provider to alternatively contact the customer directly, or any other service options. The designated service provider can choose to send a notification to the customer via the central notification manager. The central notification manager can send the notification to the customer using the customer contact information previously provided by the customer. The notification can be transmitted as an email, text message, or any similar electronic means for messaging.

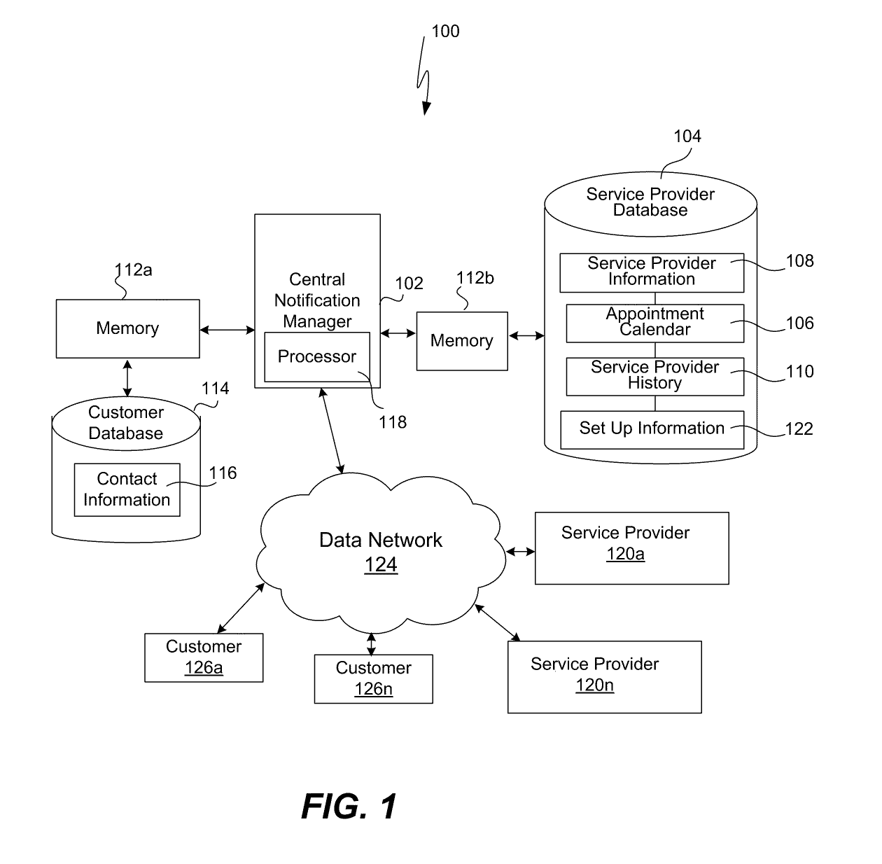

Referring to FIG. 1, an example block diagram of a notification management system. The notification management system 100 includes a central notification manager 102. In one embodiment, the central notification manager 102 may be a server. The central notification manager 102 can have a processor 118 configured to execute instructions stored in a memory 112a, 112b, wherein execution of the instructions generates a notification based on status information provided by a service provider 120a, 120n (where n is an integer). The processor 118 may also be configured to: (i) receive contact information and a designation concerning a service provider 120a-n from a customer 126a-n, the designated service provider 120a-n being selected from the plurality of service providers stored in a service provider database 102 in the memory 112b; (ii) send an alert to the designated service provider 120a-n, the alert concerning the customer 126a-n associated with the received contact information; (iii) receive status information from the service provider 120a-n in response to the alert; and (iv) send the generated notification to the customer 126a-n using the received contact information.

The system 100 may also have a memory 112b configured to store information in the service provider database 104. The service provider database 104 may provide mass storage and record information related to each of the plurality of service providers 120a-n. For example, the service provider database 104 may store service provider information 108 such as address, contact information, service provider ratings, product sold and/or service provided, hours of operation, and the like. The service provider data base 104 may also store an appointment calendar 106 whereby appointments for the service provider may be recorded or added. The service provider history 110 may also be stored such as past appointments, prior customers, contact information for the customers, and the like. The service provider database 104 can also include set up information 122 such as the maximum number of appointments per day, operating hours of the service provider, available hours customers may make an appointment, customized follow-up with existing customers, and the like. Although illustrated with the service provider database 104 configured to store the above information, this is not intended to be limiting as the above information may be stored in multiple databases.

The system 100 may also have a memory 112a configured to store customer information in a customer database 114. The customer database 114 may store information about the customer such as make of car, last service, services completed, contact information 116, email address, products ordered and the like.

The notification management system 100 can include at least one service provider 120a-n and at least one customer 126a-n. Typically, the notification management system 100 would include a plurality of different service providers 120a-n and customers 126a-n. In one embodiment, the service provider 120a-n may be an automobile repair shop. The service provider 120a-n may also be an appliance repair shop. The service provider 120a-n may be any type of retail or service provider where notification to customers 126a-n about an upcoming, pending, or completed order or service is contemplated or necessary.

In one embodiment of the notification management system 100 illustrated in FIG. 1, the customer 126a-n may select or designate a specific service provider 120a-n in which to transmit their contact information to. The contact information and the designated service provider may be transmitted to the central notification manger 102 via data network 124. Central notification manager 102 may then send an alert, concerning the customer 126a-n, to the designated service provider 120a-n. The alert may also contain the received customer contact information. The alert transmitted to the service provider 120a-n may be an email, text message, facsimile or any similar electronic means for messaging.

The service provider 120a-n may respond to the alert accordingly. For example, if the alert is requesting status on an oil change service for the customer's car, the service provider 120a-n may transmit a status information of “Work In Progress”, “Wash and Final Inspection”, Ready For Pickup”, “Waiting Customer Authorization”, or any other status related information. In another example, if the alert is requesting status of an order, the retail store may transmit a status information of “Pending Delivery”, “Product Ready For Pickup”, “Awaiting Customer Payment”, “Product No Longer Available”, or any other status related information. Alternatively, the service provider 120a-n may transit personalized comments or notes with the status information and/or contact the customer directly via telephone or any other means of communication.

Once the status information is transmitted from the service provider 120a-n to the central notification manager 102, the central notification manager 102 may generate a notification to the customer 126a-n using the contact information previously provided by the customer 126a-n. All information received by the central notification manager 102, such as customer information, status information, and the like may be stored in the customer database 114 and/or the service provider database 104. The notification to the customer 126a-n may be an email, text message, facsimile or any similar electronic means for messaging transmitted to an electronic device of the customer 126a-n such as a mobile phone, computer, and the like.

In another embodiment of the notification management system 100 illustrated in FIG. 1, the service provider 120a-n may transmit status information concerning a specific customer 126a-n to the central notification manager 102. The status information may be any related information as discussed above. For example, if the alert is requesting status on an oil change service for the customer's car, the service provider 120a-n may transmit a status information of “Work In Progress”, “Wash and Final Inspection”, Ready For Pickup“, “Waiting Customer Authorization”, or any other status related information. In another example, if the alert is requesting status of an order, the retail store may transmit a status information of “Pending Delivery”, “Product Ready For Pickup”, “Awaiting Customer Payment”, “Product No Longer Available”, or any other status related information. Alternatively, the service provider 120a-n may transit personalized comments or notes with the status information and/or contact the customer directly via telephone.

Once the status information is transmitted from the service provider 120a-n to the central notification manager 102, the central notification manager 102 may generate a notification to the customer 126a-n using the contact information 116 stored in the customer database 114. All information received by the central notification manager 102, such as customer information, status information, and the like may be stored in the customer database 114 and/or the service provider database 104.

In one embodiment, the central notification manager 102 may automatically and periodically send an alert to the service provider 120a-n. The alert may be transmitted at predetermined time intervals. For example, the alert may be transmitted every 2 hours to the service provider 120a-n to follow-up on the service of a car. In another embodiment, the service provider 120a-n may automatically and periodically transmit status information to the central notification manager 102 concerning particular existing customers. For example, the service provider 120a-n may include in the set up information 122 in the service provider database 104 a provision or rule to transmit a “Work in Progress” status information to a customer every hour until otherwise notified by the service provider 120a-n that the work is complete. This results in the appearance that the service provider 120a-n is continually in contact and communication with the customer 126a-n, which results in better customer service, repeat customers, and increased customer referrals. The notification to the customer 126a-n may be an email, text message, facsimile or any similar electronic means for messaging transmitted to an electronic device of the customer 126a-n such as a mobile phone, computer, and the like.

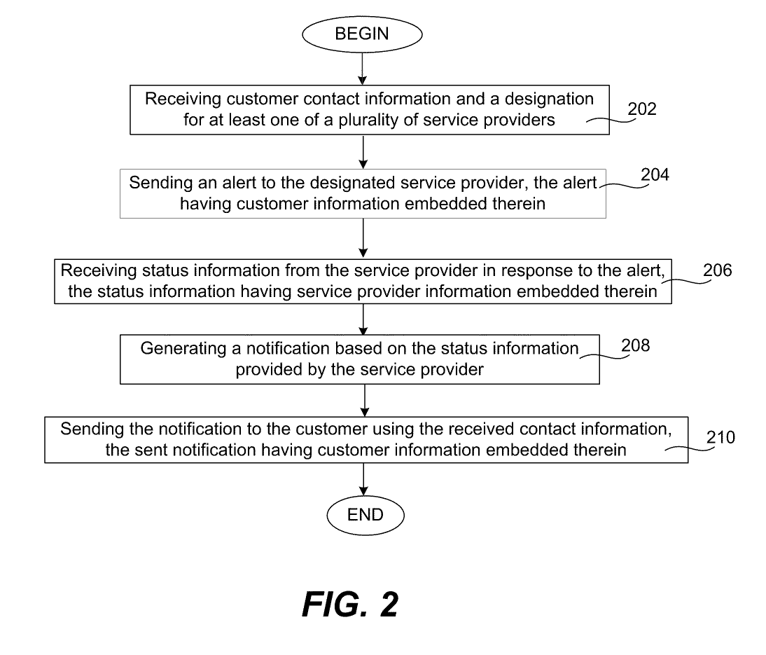

FIG. 2 illustrates a flow chart of an example method of notification management. The central notification manager may receive customer contact information and a designation for at least one of a plurality of service providers at 202 via a data network. The central notification manager may then send an alert, concerning the customer, to the designated service provider at 204. The alert may contain information embedded in the alert. For example, the alert may have customer information embedded such as a unique customer code or identification, name, origination source, destination source, type of message, and the like. In one embodiment, the information can be embedded in the header of the alert message. In another embodiment, the information can be embedded in the message itself. Embedding the information somewhere in the alert may help to direct and/or redirect the message to the appropriate destination. The alert may also contain the received customer contact information. The alert transmitted to the service provider may be an email, text message, facsimile or any similar electronic means for messaging.

The central notification manager may receive status information from the service provider in response to the alert at 206. The service provider may respond to the alert accordingly and transmit the status information to the central notification manager. The status transmission may contain information embedded therein. For example, the transmission may have service provider information embedded such as a unique customer code or identification, name, origination source, destination source, type of message, and the like. In one embodiment, the information can be embedded in the header of the status transmission message. In another embodiment, the information can be embedded in the message itself. Embedding the information somewhere in the transmission may help to direct and/or redirect the message to the appropriate destination.

In one embodiment, if the alert requested status on a customized wedding cake, the service provider may transmit a status information of “Cake In Oven”, “Decorating Cake”, “Ready For Pickup”, “Waiting Customer Payment”, or any other status related information. Alternatively, the service provider may transit personalized comments or notes to the customer such as “Hi Sally, Your cake will be ready for pick up at 6 pm tomorrow”. In another embodiment, the service provider may contact the customer directly via telephone or any other means of communication.

Once the status information is transmitted from the service provider to the central notification manager, the central notification manager may generate a notification to the customer based on the status information provided by the service provider at 208. The notification is then sent to the customer using the previously received contact information at 210. The sent notification may contain information embedded in the alert. For example, the alert may have customer information embedded such as a unique customer code or identification, name, origination source, destination source, type of message, and the like. In one embodiment, the information can be embedded in the header of the sent notification. In another embodiment, the information can be embedded in the sent notification itself. Embedding the information somewhere in the sent notificaiton may help to direct and/or redirect the message to the appropriate destination. The notification to the customer may be an email, text message, facsimile or any similar electronic means for messaging transmitted to an electronic device of the customer such as a mobile electronic device, mobile telephone, computer, and the like.

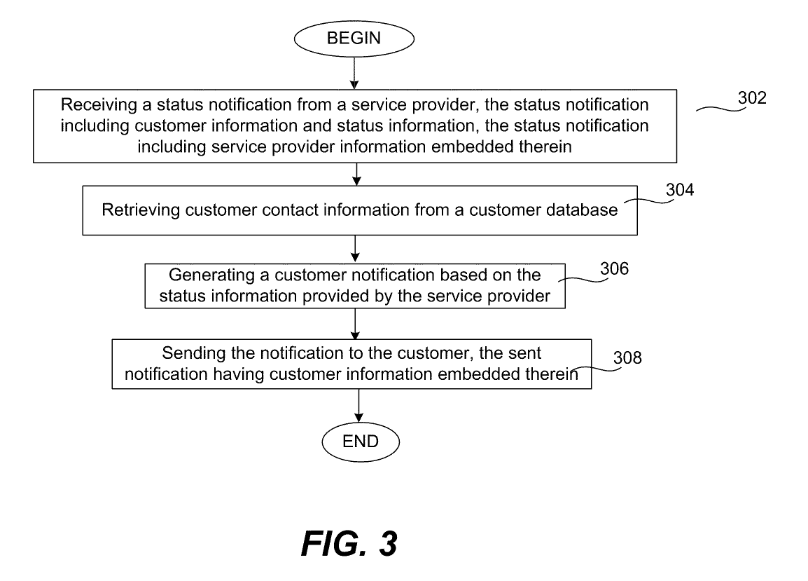

FIG. 3 illustrates a flow diagram of another example method of notification management. The central notification manager may receive a status notification from a service provider, the status notification may include customer information, such as the customer name, and status information at 302. The status information may be any related information as discussed above. Alternatively, the service provider may transit personalized comments to the customer and/or contact the customer directly via telephone.

In one embodiment, the status notification may contain information embedded in the alert. For example, the alert may have service provider information embedded such as a unique customer code or identification, name, origination source, destination source, type of message, and the like. In one embodiment, the information can be embedded in the header of the status notification. In another embodiment, the information can be embedded in the notification itself. Embedding the information somewhere in the notification may help to direct and/or redirect the notification to the appropriate destination.

Once the status information is transmitted from the service provider to the central notification manager, the central notification manager may retrieve the customer's contact information from the customer database at 304. The central notification manager may then generate a customer notification based on the status information provided by the service provider at 306. The customer notification may be sent to the customer at 308. The sent notification may contain information embedded in the alert. For example, the sent notification may have customer information embedded such as a unique customer code or identification, name, origination source, destination source, type of message, and the like. In one embodiment, the information can be embedded in the header of the sent notification. In another embodiment, the information can be embedded in the sent notification itself. Embedding the information somewhere in the sent notification may help to direct and/or redirect the message to the appropriate destination. The notification to the customer may be an email, text message, facsimile or any similar electronic means for messaging transmitted to an electronic device of the customer such as a mobile electronic device, mobile telephone, computer, and the like.

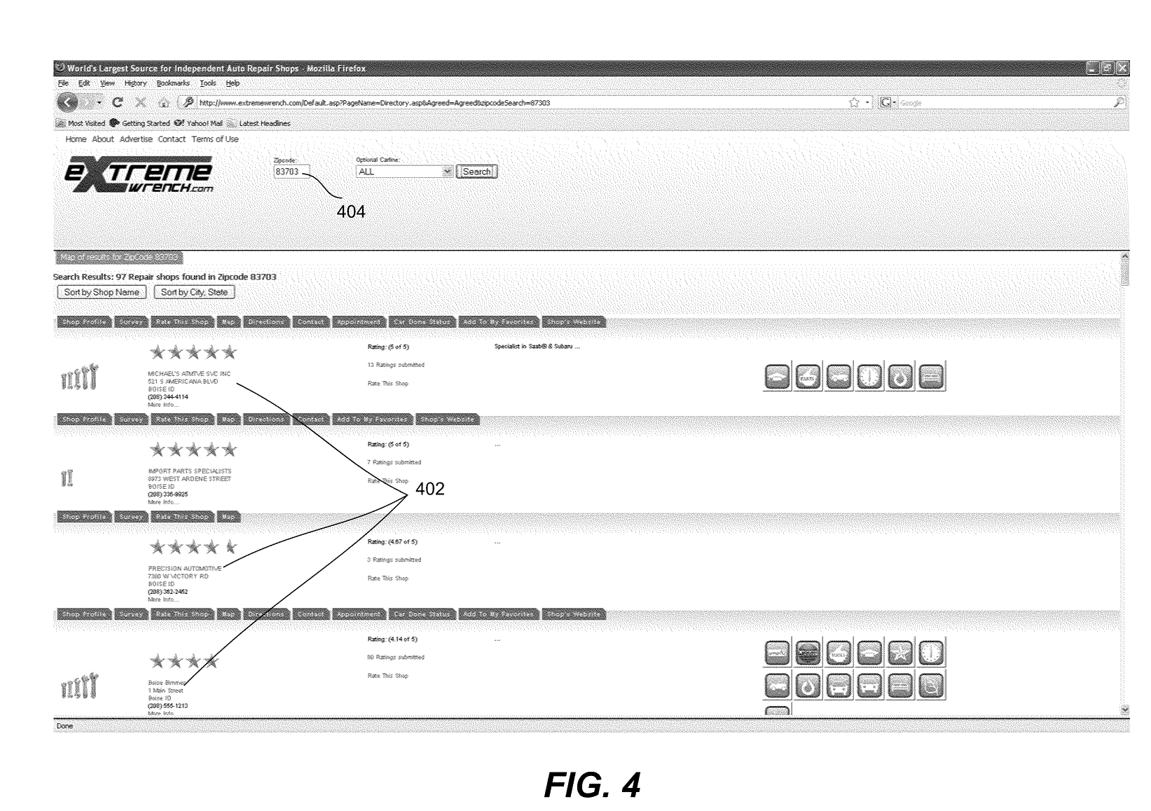

FIG. 4 illustrates a screen shot of an example listing of a plurality of service providers. A customer searching for a service provider may be provided with a list of service providers 402.

The service providers may be searched based on location (i.e. zip code 404), type of service, customer requirements/preferences, or a combination of factors or criteria.

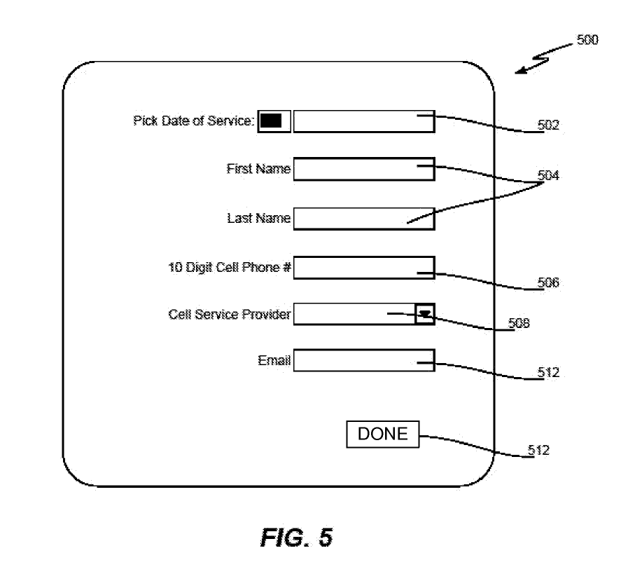

FIG. 5 illustrates an example graphical user interface used to obtain customer contact information. Once a service provider 402 is designated by the customer (i.e. once the notification manager 102 of FIG. 1 receives an input from the customer selecting a designated service provider), and customer requests a service or product from the service provider, the customer may be prompted to input contact information such as date service requested 502, name 504, phone number 506, cell service provider 508, email address 510, and the like into a graphical user interface 500. The contact information may be customized by the service provider as necessary or desired. For example, if the service provider would like an alternative phone number to contact the customer, this may also be displayed on the graphical user interface 500. Once complete, the customer may click “Done” 512 to transmit the information to the central notification manager.

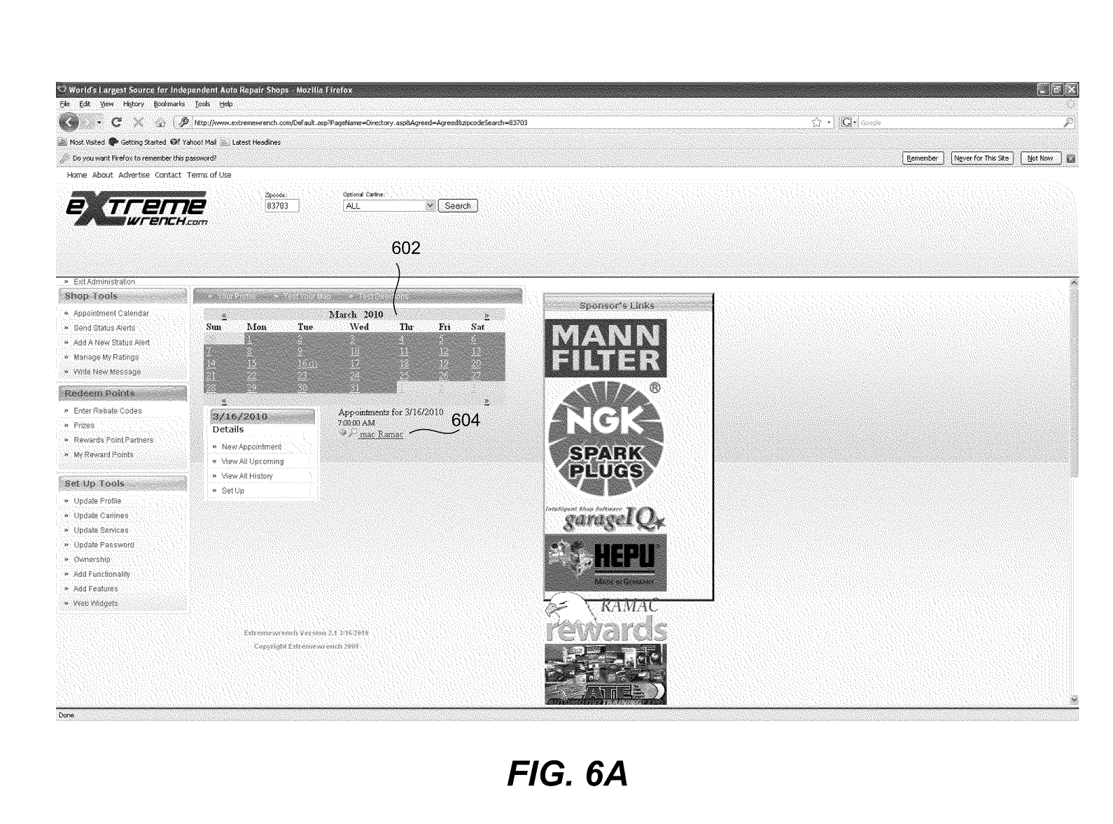

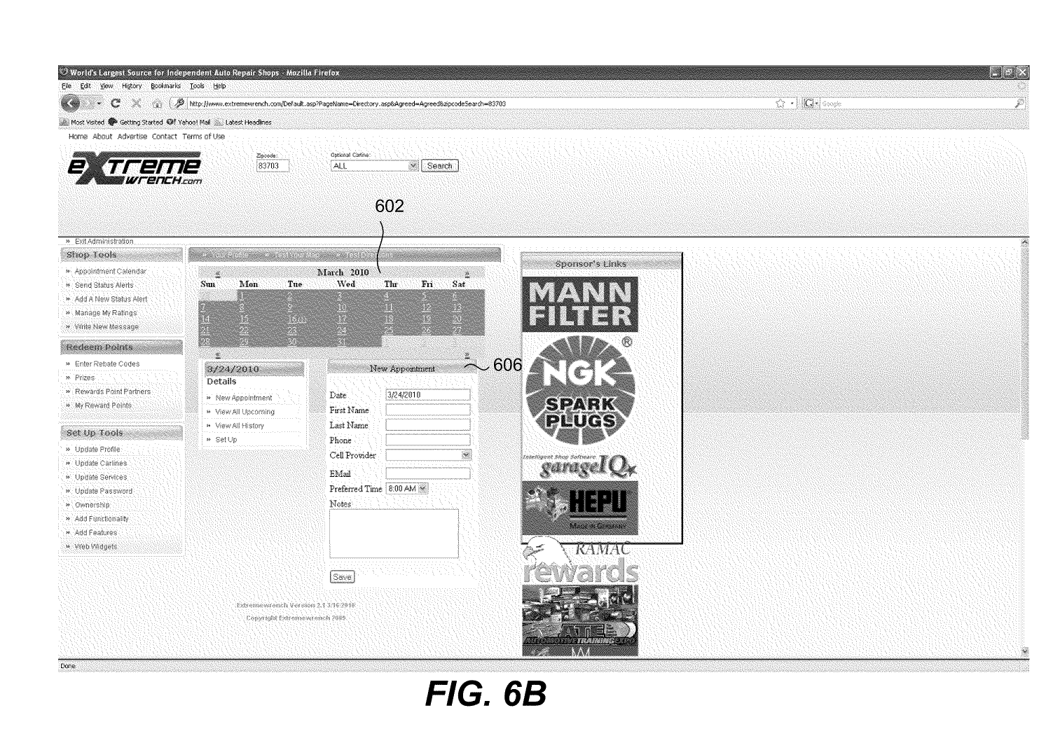

FIGS. 6A and 6B illustrate example screen shots of an appointment calendar. The appointment calendar may be stored, for example, on the service provider database 104 illustrated in FIG. 1. The service provider may receive an alert 604 concerning the customer. The alert may appear as a new customer entry/appointment in the database 606 as illustrated in FIG. 6B, which may then be recorded in the appointment calendar 602. In another embodiment, the alert may appear as updated customer information for an existing customer. The alert may be an email, text message, facsimile or any similar electronic means for messaging the service provider. In another embodiment, the service provider may manually input and enter the new appointment 606 into the appointment calendar 602.

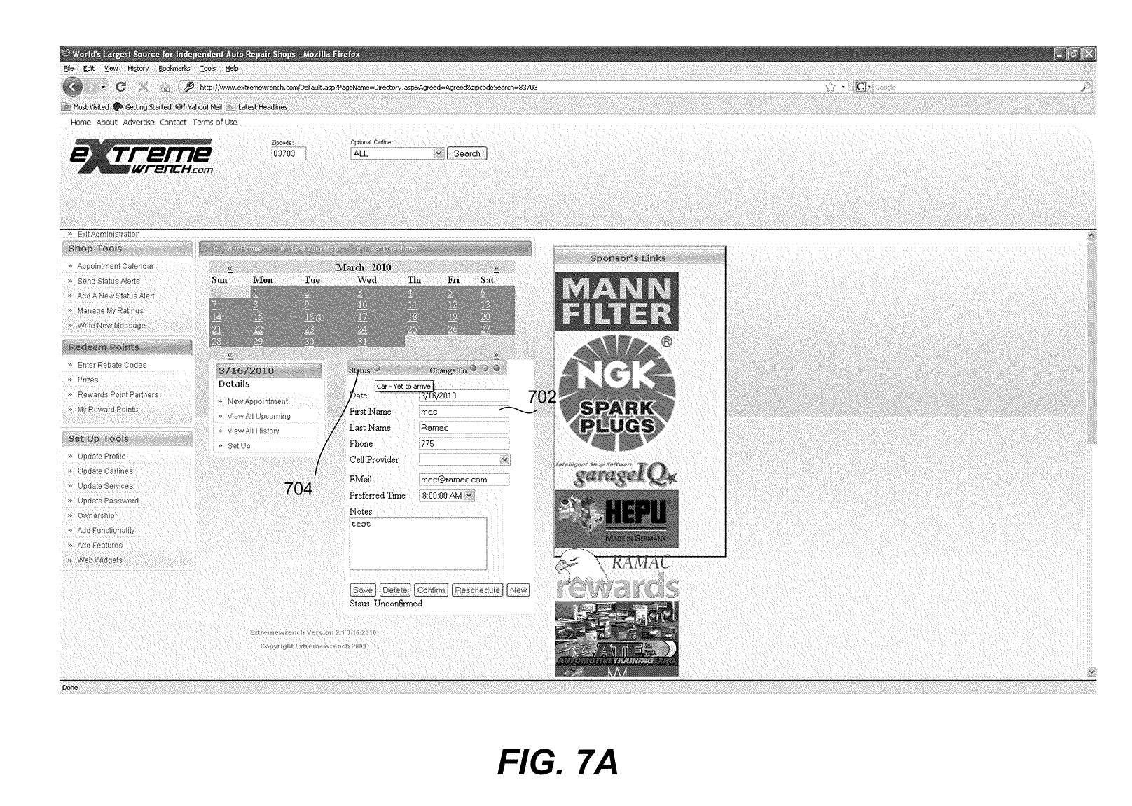

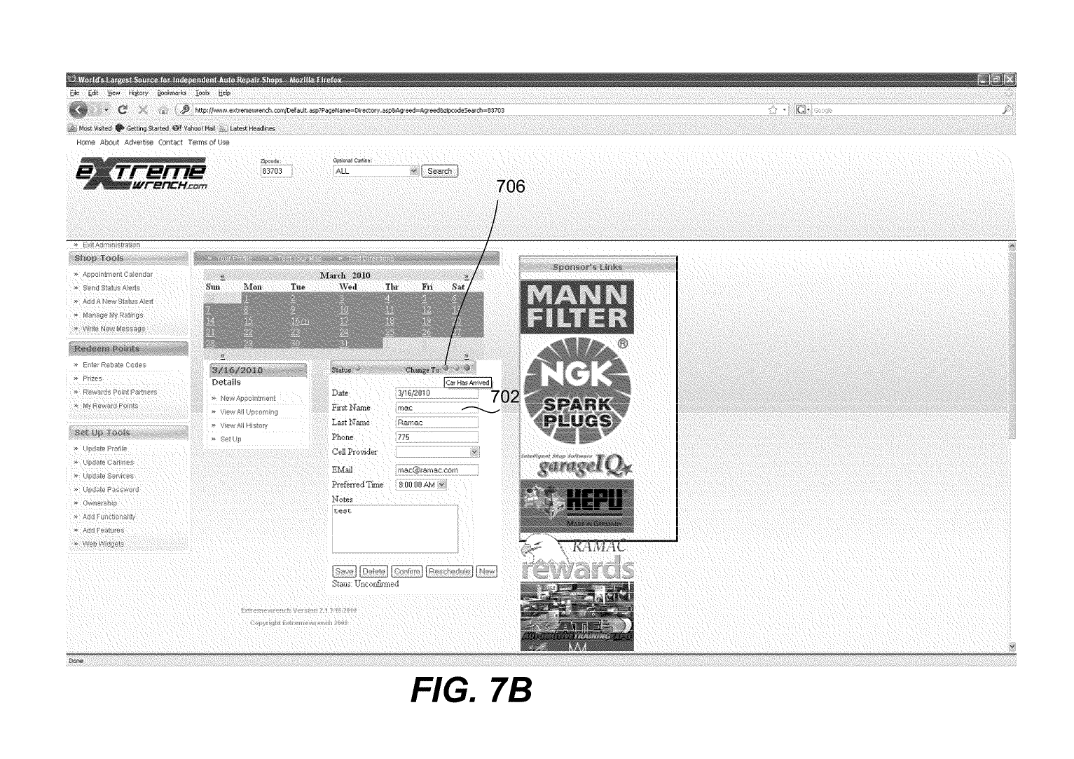

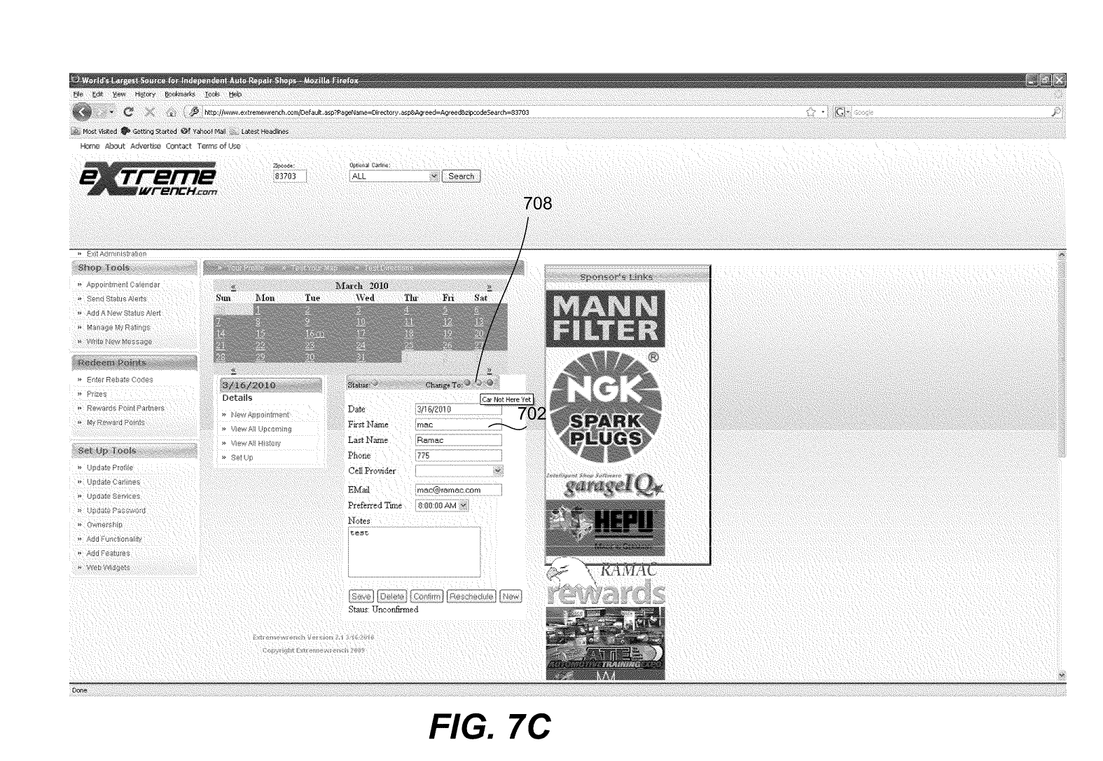

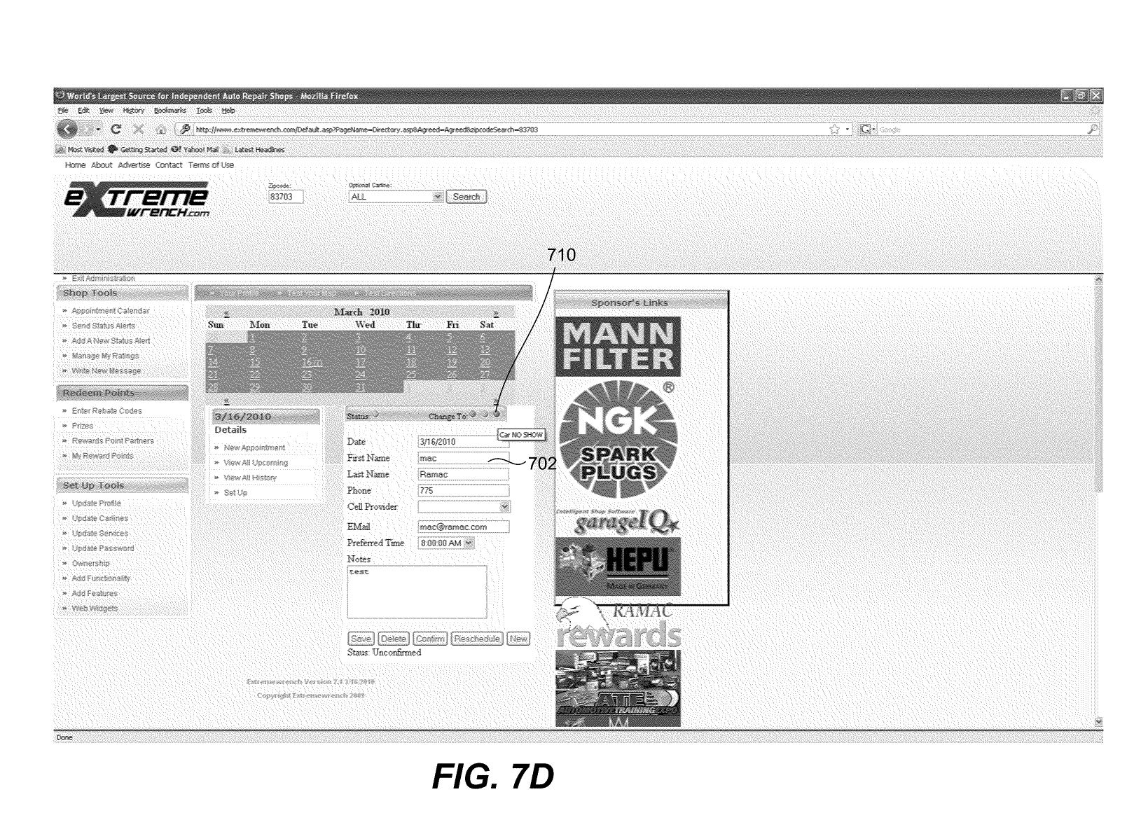

In response to the alert, the service provider may provide status information to the central notification manager. FIGS. 7A-7D illustrate sample screen shots of example status information for a customer. As illustrated in FIG. 6, an appointment for “Mac Ramac” 604 was schedules on Mar. 16, 2010 at 7:00AM. As illustrated in FIG. 7A, the status information 704 is “Car—Yet To Arrive”. Thus, the Mac Ramac's car has not yet arrived by 7:00 AM. Referring to FIG. 7B, the service provider may change the status 704 by clicking the “Car Has Arrived” button 706 if Mac Ramac's car arrives at the service provider. Referring to FIG. 7C, in another embodiment, the service provider may change the status 704 by clicking the “Car Not Here Yet” button 708 if Mac Ramac's car did not arrive at the service provider by mid-morning, such as around 10:00 AM. Referring to FIG. 7D, in still another embodiment, the service provider may change the status 704 by clicking the “Car No Show” button 710 if Mac Ramac's car did not arrive at the service provider by mid-afternoon, such as around 4:00 PM.

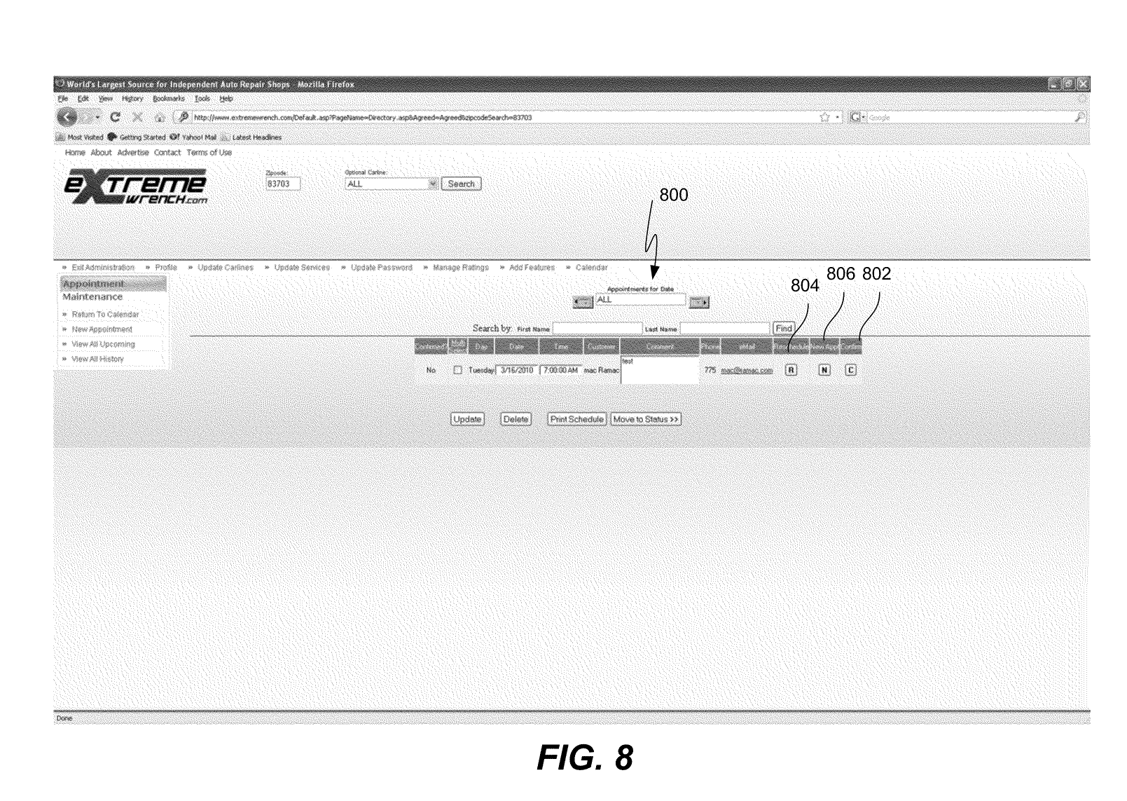

FIG. 8 illustrates an example screen shot of upcoming appointments. In another embodiment, the service provider may provide status information via a list of upcoming appointments 800 displayed to the service provider. As illustrated in FIG. 8, the upcoming appointments list displays an upcoming appointment for Mac Ramac scheduled on Tuesday, Mar. 16, 2010 at 7:00 AM for a “Test”. The service provider may confirm the appointment 802, reschedule 804, or schedule another new appointment for the customer 806. In one embodiment, the list of upcoming appointments 800 may be, for example, stored on the service provider database 104 in the appointment calendar 106 illustrated in FIG. 1. In another embodiment, the list of upcoming appointments 800 may also be, for example, stored on the service provider's own server.

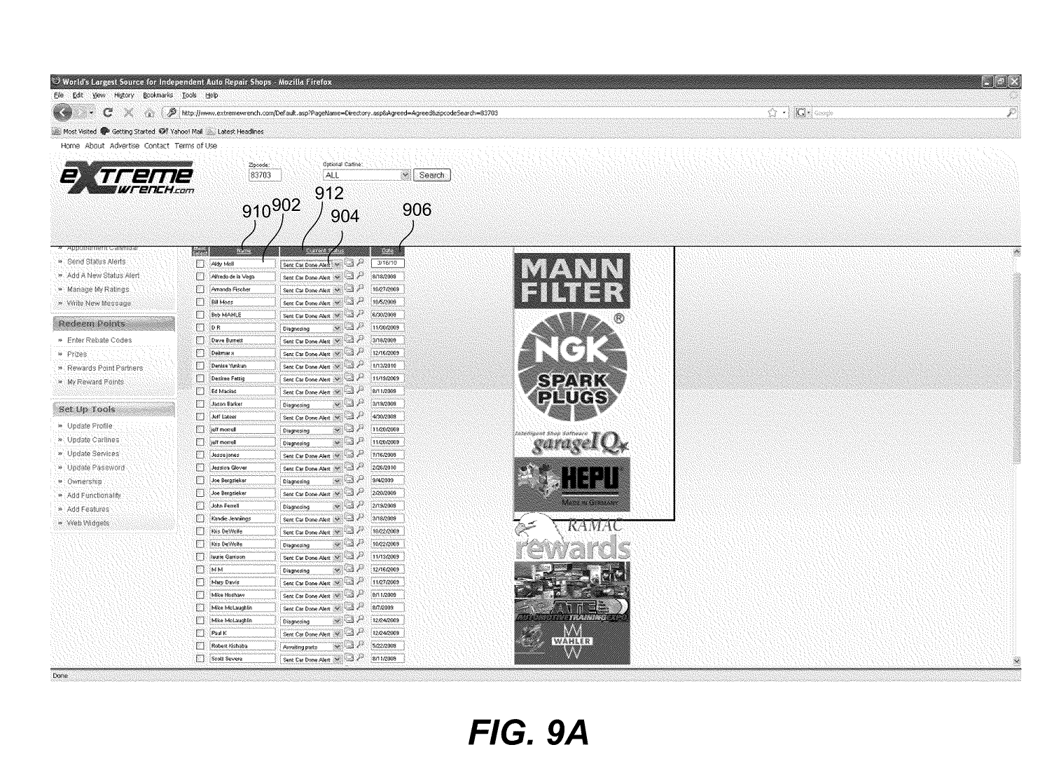

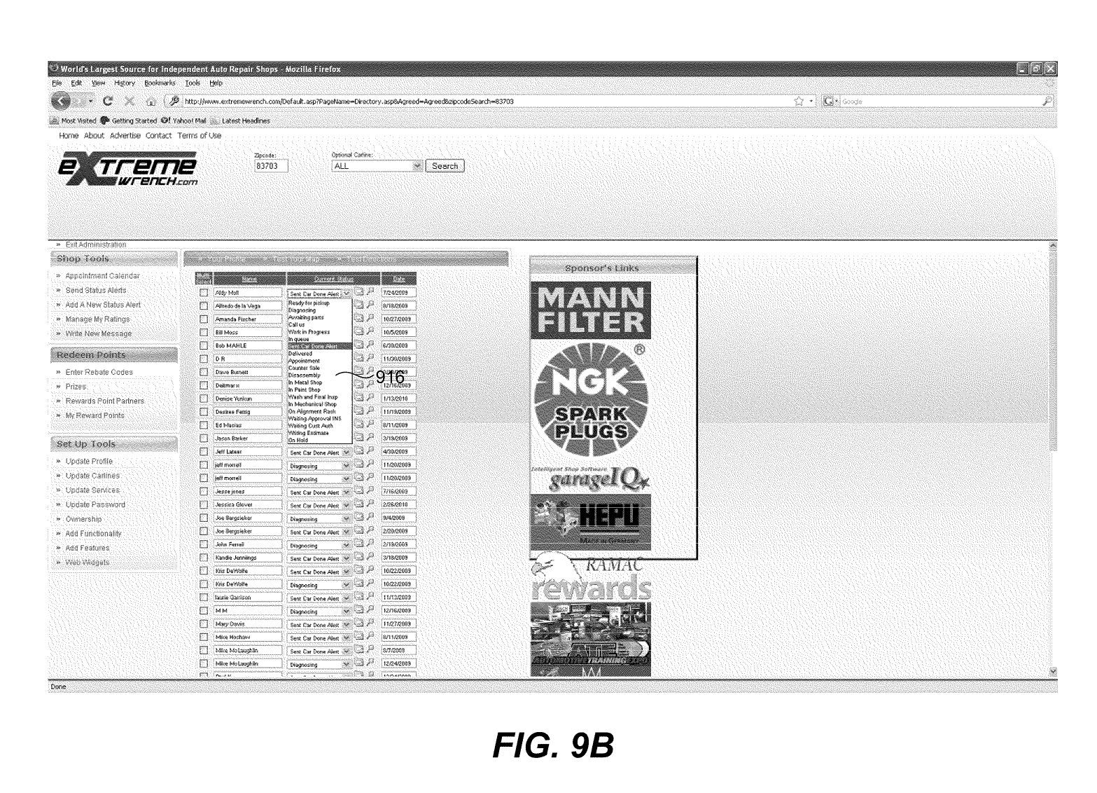

FIGS. 9A and 9B illustrate example screen shots listing customer information and status information. Referring to FIG. 9A, the service provider may be provided a list of customers 910 and their status 912. For example, Aldy Moll 902 was sent a “Car Done Alert” 904 on Mar. 16, 2010 906. However, each customer 910 may be associated with a drop-down list 916 providing status options, as illustrated in FIG. 9B. For example, the status options may be “Ready For Pickup”, “Awaiting Parts”, “Disassembly”, and other status options. In one embodiment, the list of customers 910 may be, for example, stored on the service provider database 104 illustrated in FIG. 1. In another embodiment, the list of customers 910 may also be, for example, stored on the service provider's own server.

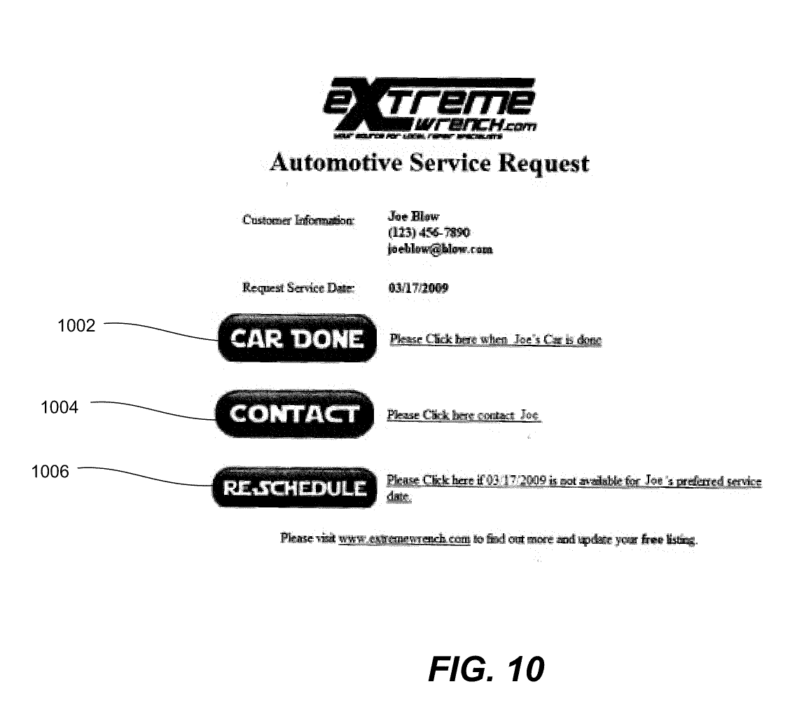

FIG. 10 illustrates an example screen shot of an example alert. In one embodiment, an alert 1000 may be transmitted to the service provider as an email, text message, or a customized graphical user interface. The alert 1000 may include various options for indicating and/or transmitting status information to the customer. As illustrated in FIG. 10, the service provider may click “Car Done” 1002 if the service is complete for Joe Blow, “Contact” 1004 to contact the customer, and/or click “Reschedule” 1006 if it is necessary to reschedule the appointment for Joe Blow. Although illustrated with only three options, this is not intended to be limiting as other status options may be contemplated.

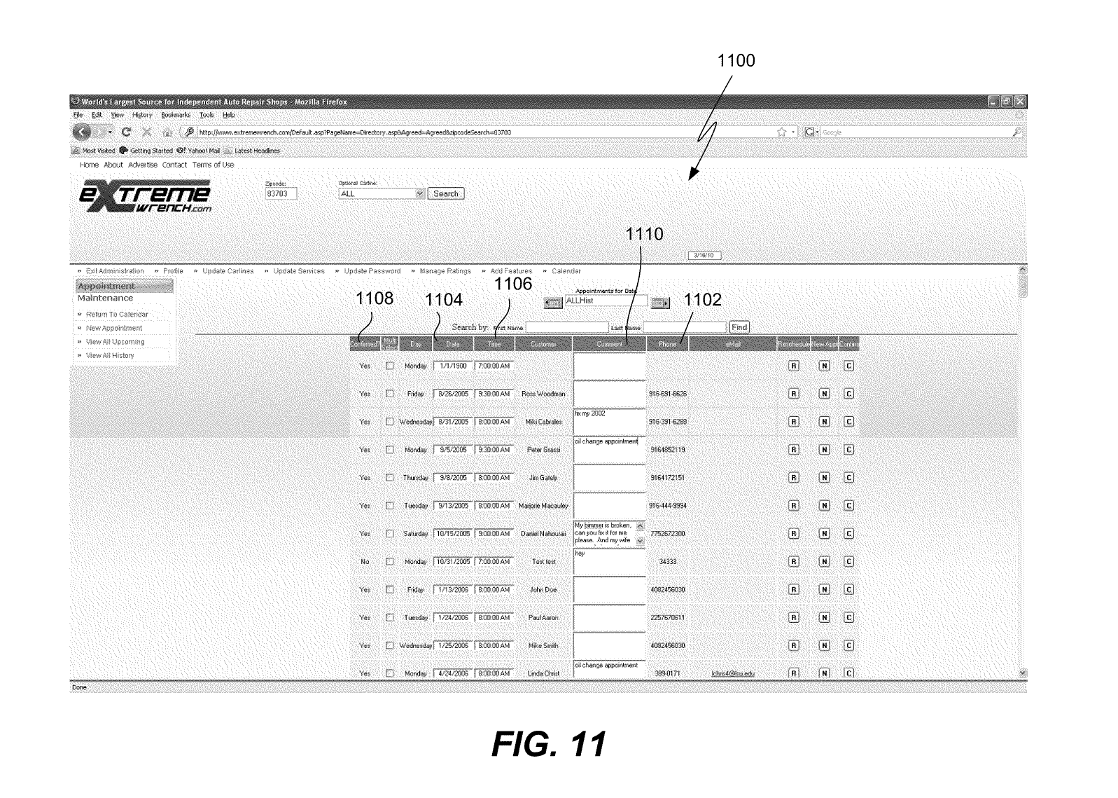

FIG. 11 illustrates a sample screen shot displaying a history list of customer appointments. A list of previous customer appointments 1100 may be displayed to the service provider. The list may include such information such as customer contact information 1102, date of service 1104, time of appointment 1106, whether the appointment was confirmed 1108, and any other information desired by the user, such as comments 1110 made by the customer and/or service provider. In one embodiment, the history list of customer appointments 1100 may be, for example, stored on the service provider database 104 under service provider history 110 illustrated in FIG. 1. In another embodiment, the history list of customer appointments 1100 may be, for example, stored on the service provider's own server.

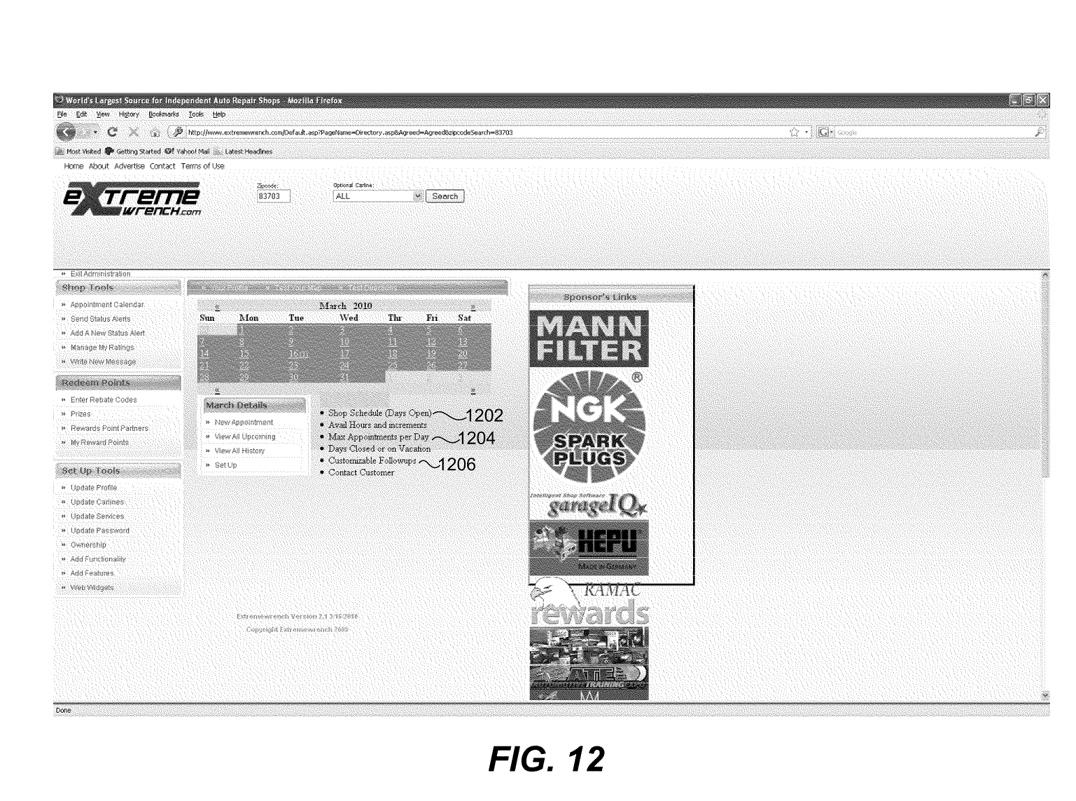

FIG. 12 illustrates an example screen shop to set up customer appointments by a service provider. The service provider may be provided the opportunity to customize the appointment calendar, customer notifications, and the like. For example, as illustrated in FIG. 12, the service provider may input the days that shop is open or the shop schedule 1202, the maximum appointments the central notification manager can schedule 1204, and the service provider may customize follow-ups 1206. For example, after a service is complete, the service provider may elect to send the customer an evaluation form and/or questionnaire to evaluate the service performed by the service provider. In another example, after a service is complete, the service provider may elect to send the customer a follow-up to ensure the vehicle or product is working well. The set up is to enhance the experience of the service provider.

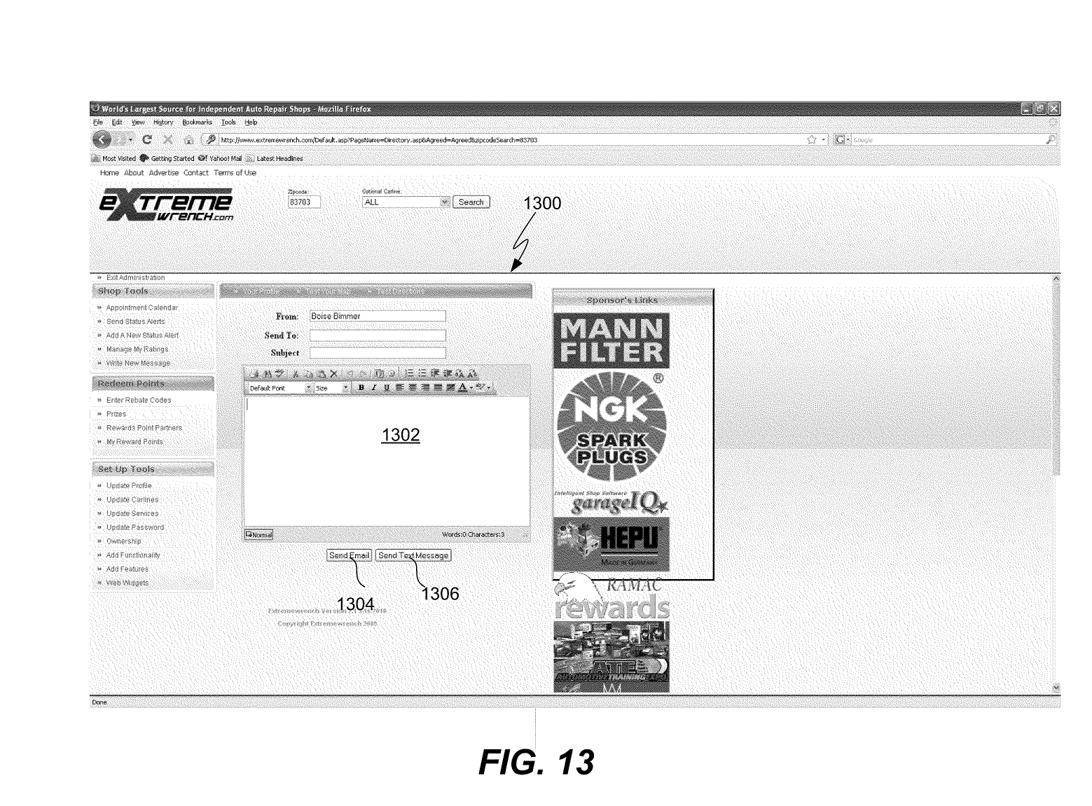

FIG. 13 illustrates an example screen shot of a graphical user interface a service provider may use to contact a customer. As stated above, the service provider may contact the customer directly. FIG. 13 illustrates a graphical user interface 1300 whereby the service provider may type a message 1302 and either send the message via email 1304 or text message 1306 to the customer. Although illustrated with the use of email or text message, any electronic delivery of the message is contemplated, such as facsimile.

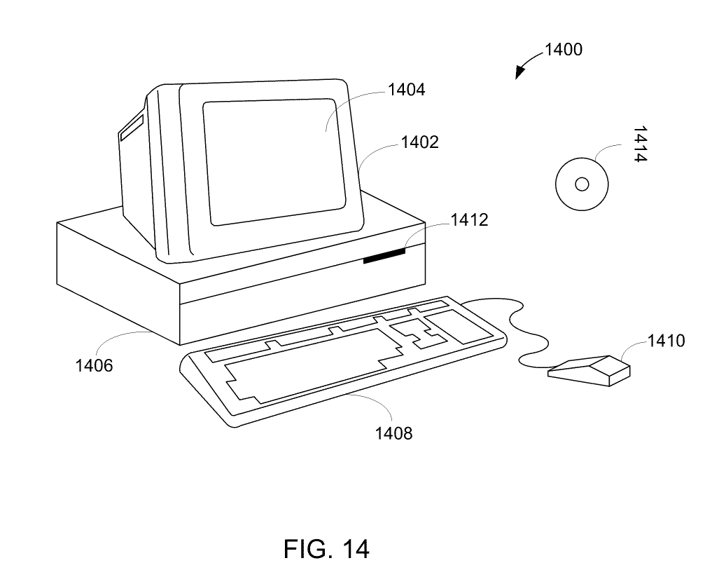

FIG. 14 is an exemplary computer system 1400 suitable for use with at least one embodiment of the invention. The methods, processes and/or graphical user interfaces discussed above can be provided by a computer system. The computer system 1400 includes a display monitor 1402 having a single or multi-screen display 1404 (or multiple displays), a cabinet 1406, a keyboard 1408, and a mouse 1410. The mouse 1410 is representative of one type of pointing device. The cabinet 1406 houses a processing unit (or processor), system memory and a hard drive (not shown). The cabinet 1406 also houses a drive 1412, such as a DVD, CD-ROM or floppy drive. The drive 1412 can also be a removable hard drive, a Flash or EEPROM device, etc. Regardless, the drive 1412 may be utilized to store and retrieve software programs incorporating computer code that implements some or all aspects of the invention, data for use with the invention, and the like. Although CD-ROM 1414 is shown as an exemplary computer readable storage medium, other computer readable storage media including floppy disk, tape, Flash or EEPROM memory, memory card, system memory, and hard drive may be utilized. In one implementation, a software program for the computer system 1400 is provided in the system memory, the hard drive, the drive 1412, the CD-ROM 1414 or other computer readable storage medium and serves to incorporate the computer code that implements some or all aspects of the invention.

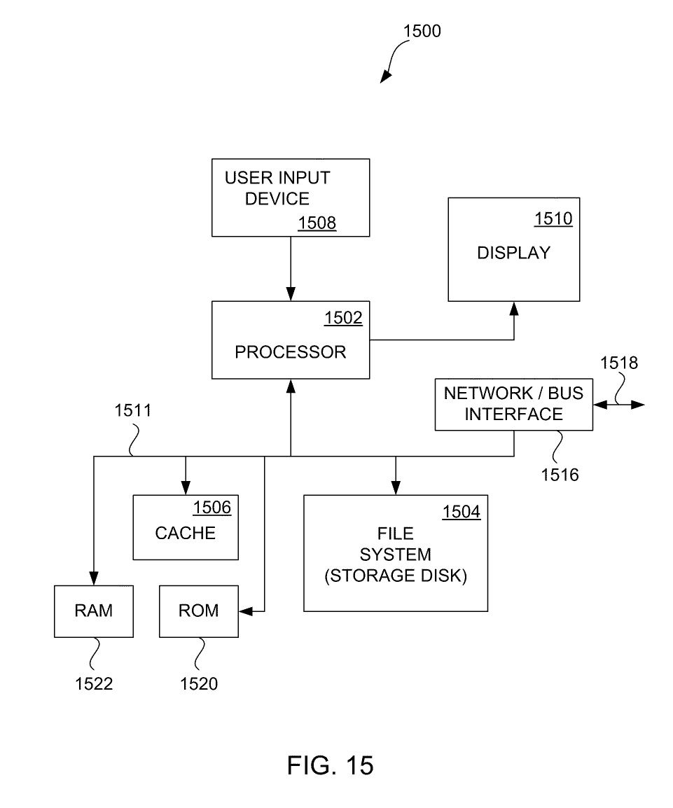

FIG. 15 is a block diagram of an example computing system. The computing system 1500 may be the central notification manager of FIG. 1, customer of FIG. 1, or any other server or computing device used to carry out the various embodiments disclosed herein. The computing system 1500 may include a processor 1502 that pertains to a microprocessor or controller for controlling the overall operation of the computing system 1500. The computing system 1500 stores information, such as a list of customers, customer information, a list of service providers, service provider information, service provider appointments, service provider history, and service provider set up requirements in a file system 1504 and a cache 1506. The file system 1504 is, typically, a storage disk or a plurality of disks. The file system 1504 typically provides high capacity storage capability for the computing system 1500. However, since the access time to the file system 1504 is relatively slow, the computing system 1500 can also include a cache 1506. The cache 1506 is, for example, Random-Access Memory (RAM) provided by semiconductor memory. The relative access time to the cache 1506 is substantially shorter than for the file system 1504. However, the cache 1506 does not have the large storage capacity of the file system 1504. Further, the file system 1504, when active, consumes more power than does the cache 1506. The computing system 1500 also includes a RAM 1520 and a Read-Only Memory (ROM) 1522. The ROM 1522 can store programs, utilities or processes to be executed in a non-volatile manner. The RAM 1520 provides volatile data storage, such as for the cache 1506.

The computing system 1500 also includes a user input device 1508 that allows a user of the computing system 1500 to interact with the computing system 1500. For example, the user input device 1508 can take a variety of forms, such as a button, keypad, dial, and the like. Still further, the computing system 1500 includes a display 1510 (screen display) that can be controlled by the processor 1502 to display information, such as a list of upcoming appointments, to the user. A data bus 1511 can facilitate data transfer between at least the file system 1504, the cache 1506, the processor 1502, and the CODEC 1512.

In one embodiment, the computing system 1500 serves to store a plurality of customer and service provider information the file system 1504. When a user desires to have the computing system display a particular list, such as a list of upcoming appointments, the list of upcoming appointments may be displayed on the display 1510.

The computing system 1500 may also include a network/bus interface 1516 that couples to a data link 1518. The data link 1518 allows the computing system 1500 to couple to a host computer or data network, such as the Internet. The data link 1518 can be provided over a wired connection or a wireless connection. In the case of a wireless connection, the network/bus interface 1516 can include a wireless transceiver.

While embodiments and applications of this invention have been shown and described, it would be apparent to those skilled in the art having the benefit of this disclosure that many more modifications than mentioned above are possible without departing from the inventive concepts herein.

What is claimed is:

1. A system of notification management having a notification manager, the notification manger comprising:
a memory configured to store instructions and to store information concerning a plurality of service providers;
a processor configured to execute the instructions stored in the memory, wherein execution of the instructions generates a notification based on status information provided by a service provider, the processor configured to:
receive contact information and a designation concerning a service provider from a customer, the designated service provider being selected from the plurality of service providers stored in memory;
send an alert to the designated service provider, the alert concerning the customer associated with the received contact information;
receive status information from the service provider in response to the alert; and
send the generated notification to the customer using the received contact information.

2. The system of claim 1, wherein the generated notification is a text message and wherein the text message is transmitted to an electronic mobile device of the customer.

3. The system of claim 1, wherein the generated notification is an electronic mail message and wherein the electronic mail message in transmitted to an electronic device of the customer.

4. The system of claim 1, wherein the alert and status information relate to automotive services.

5. The system of claim 1, wherein the contact information and status information is stored in a customer database.

6. The system of claim 1, wherein the alert is sent to the designated service provider at predetermined time intervals.

7. The system of claim 1, wherein the status information is received from the service provider at predetermined time intervals.

8. A system of notification management, comprising:
a central notification manager having a processor configured to:
receive status notification from one of a plurality of service providers, the status notification including customer information and a status information;
retrieve customer contact information from a customer database;
generate a customer notification based on the status information provided in the status notification; and
send the customer notification to a customer based upon the customer contact information, the customer notification including the status information provided by the service provider; and
a service provider server having a processor configured to:
receive a status update on the customer; and
transmit a status notification concerning the customer to the central notification manager.

9. The system of claim 8, wherein the generated customer notification is a text message and wherein the text message is transmitted to an electronic mobile device of the customer.

10. The system of claim 8, wherein the generated customer notification is an electronic mail message and wherein the electronic mail message in transmitted to an electronic device of the customer.

11. The system of claim 8, wherein the customer notification and status information relate to automotive services.

12. The system of claim 8, wherein the customer contact information and status information is stored in a customer database.

13. The system of claim 8, wherein the status notification is received from the service provider at predetermined time intervals.

14. A method of notification management, comprising:
receiving customer contact information and a designation concerning a service provider;
sending an alert to the designated service provider, the alert concerning a customer associated with the received contact information;
receiving status information from the service provider in response to the alert;
generating a notification based on the status information provided by the service provider; and
sending the notification to the customer using the received contact information.

15. The method of claim 14, wherein the sending the notification further comprises transmitting a text message to an electronic mobile device of the customer.

16. The method of claim 14, wherein the sending the notification further comprises transmitting an electronic mail message to an electronic device of the customer.

17. The method of claim 14, further comprising storing the customer contact information, designated service provider, and status information in a customer database.

18. The method of claim 14, wherein the sending an alert, receiving status information, and generating a notification occur at predetermined time intervals.

19. The method of claim 14, wherein the receiving status information, and generating a notification occur at predetermined time intervals.

20. A computer-readable storage medium, having embodied thereon a program, the program being executable by a processor to perform a method for notification management, the method comprising;
receiving customer contact information and a designation concerning a service provider;
sending an alert to the designated service provider, the alert concerning the customer associated with the received contact information;
receiving status information from the service provider in response to the alert;
generating a notification based on the status information provided by the service provider; and
sending the notification to the customer using the received contact information.
